(19) United States
(12) Patent Application Publication
(10) Pub. No.: US 2026/0312782 A1
(43) Pub. Date: Oct. 8, 2026

(54) METHOD AND APPARATUS TO ACCOUNT FOR COLLISION BETWEEN UPLINK SUB-BAND AND SYNCHRONIZATION SIGNAL BLOCK SYMBOLS

(71) Applicant: Apple Inc., Cupertino, CA (US)

(72) Inventors: Seyed Ali Akbar FAKOORIAN, San Diego, CA (US); Dawei ZHANG, Saratoga, CA (US); Wei ZENG, Saratoga, CA (US); Chunhai YAO, Beijing (CN); Huaning NIU, San Jose, CA (US); Weidong YANG, San Diego, CA (US); Hong HE, San Jose, CA (US)

(21) Appl. No.: 19/483,148

(22) PCT Filed: May 11, 2023
(86) PCT No.: PCT/CN2023/093570

§ 371 Date: Nov. 10, 2025

(51) Int. Cl. H04L 5/14; H04W 24/08

(52) U.S. Cl. CPC H04L 5/14; H04W 24/08

(57) ABSTRACT

Embodiments relate to a method and apparatus for radio resource management (RRM) for user equipment (UE) in communication with a base station that accounts for collision between uplink (UL) sub-band and synchronization signal block (SSB) symbols. In particular, embodiments relate to: receiving a bit mask at the UE, the bit mask indicating whether the UE is to use a synchronization signal block (SSB) overlapping with sub-band full duplex (SBFD) symbols for SSB measurement or uplink (UL) transmission, and, based upon the received the bit mask, the UE performs SSB measurement or uplink (UL) transmission.

### FIELD OF INVENTION

This invention relates generally to the field of wireless communication, and more particularly, to a method and apparatus for radio resource management (RRM) for user equipment (UE) in communication with a base station that accounts for collision between uplink (UL) sub-band and synchronization signal block (SSB) symbols.

### BACKGROUND OF THE INVENTION

In a wireless communications network, user equipment (UE) may communicate with a base station of the network by establishing a radio link between the UE and the base station. In a 5G (New Radio or NR) or 4G (LTE) wireless network, a UE may receive signaling and data from the serving base station in a downlink (DL) transmission direction or transmit signaling and data to the serving base station in an uplink (UL) transmission direction.

In wireless communications networks, full-duplex (FD) operation within a time division duplex (TDD) band and in frequency division duplex (FDD) band is being envisaged for enhancements for communications between base stations (e.g., gNBs) and UEs (e.g., Rel-18 enhancements). In this instance, FD operations refer to the case, in which, at least the base station is operating in full-duplex, i.e., simultaneously, transmitting and receiving data. For example, in Rel-18, dynamic TDD and full duplex operations at the base station are being studied under the assumption of a half-duplex UE.

### SUMMARY OF THE DESCRIPTION

Embodiments relate to a method and apparatus for radio resource management (RRM) for user equipment (UE) in communication with a base station that accounts for collision between uplink (UL) sub-band and synchronization signal block (SSB) symbols. In particular, as will be described, embodiments relate to the following aspects: conditions under which an aggressor UE can keep UL transmission sub-bands in SSB symbols; and solutions for a victim UE if a base station (gNB) is performing sub-band full duplex (SBFD) operations in SSB symbols-as SSB measurements over such SSB blocks may be degraded due to UE-to-UE CLI, and/or less antenna elements/beam-forming gain at the base station (gNB).

In one embodiment, a method for a user equipment (UE) in communication with a base station is disclosed that comprises: receiving a bit mask at the UE, the bit mask indicating whether the UE is to use a synchronization signal block (SSB) overlapping with sub-band full duplex (SBFD) symbols for SSB measurement or uplink (UL) transmission; and based upon the received the bit mask, the UE performs SSB measurement or uplink (UL) transmission. In one embodiment, the bit mask is cell specific or UE-specific. In one embodiment, a pre-defined value of the bit mask indicates that SSB measurement is not to be performed and the UE is to perform UL transmission in an UL sub-band. In one embodiment, a pre-defined value of the bit mask indicates that SSB measurement is to be performed and the SSB block is to be measured within a corresponding SSB Measurement Timing Configuration (SMTC). In one embodiment, the UL transmission within SSB symbols includes a reduced maximum UE transmit power. In one embodiment, the base station applies additional transmit power to SSB symbols. In one embodiment, the UE does not measure SSB symbols that overlap with SBFD symbols.

In another type of embodiment, a user equipment (UE) in connection with a base station is disclosed that comprises: at least one antenna; at least one radio, wherein the at least one radio is configured to communicate with the base station using the at least one antenna; and at least one processor coupled to the at least one radio, wherein the at least one processor is configured to perform operations comprising: receiving a bit mask, the bit mask indicating whether the UE is to use a synchronization signal block (SSB) overlapping with sub-band full duplex (SBFD) symbols for SSB measurement or uplink (UL) transmission; and based upon the received the bit mask, performing SSB measurement or uplink (UL) transmission. In one embodiment, the bit mask is cell specific or UE-specific. In one embodiment, a pre-defined value of the bit mask indicates that SSB measurement is not to be performed and the UE is to perform UL transmission in an UL sub-band. In one embodiment, a pre-defined value of the bit mask indicates that SSB measurement is to be performed and the SSB block is to be measured within a corresponding SSB Measurement Timing Configuration (SMTC). In one embodiment, the UL transmission within SSB symbols includes a reduced maximum UE transmit power. In one embodiment, when performing SSB measurements, not measuring SSB symbols that overlap with SBFD symbols.

In another type of embodiment, a base station in connection with the UE through a network comprises: at least one antenna; at least one radio, wherein the at least one radio is configured to communicate with the network using the at least one antenna; and at least one processor coupled to the at least one radio, wherein the at least one processor is configured to perform operations comprising: commanding the radio to transmit a bit mask to UE, the bit mask indicating whether the UE is to use a synchronization signal block (SSB) overlapping with sub-band full duplex (SBFD) symbols for SSB measurement or uplink (UL) transmission. In one embodiment, the bit mask is cell specific or UE-specific. In one embodiment, a pre-defined value of the bit mask indicates that SSB measurement is not to be performed and the UE is to perform UL transmission in an UL sub-band. In one embodiment, a pre-defined value of the bit mask indicates that SSB measurement is to be performed and the SSB block is to be measured within a corresponding SSB Measurement Timing Configuration (SMTC). In one embodiment, the base station applies additional transmit power to SSB symbols.

In another type of embodiment, a base station in connection with the UE through a network, the base station comprises: at least one antenna; at least one radio, wherein the at least one radio is configured to communicate with the network using the at least one antenna; and at least one processor coupled to the at least one radio, wherein the at least one processor is configured to perform operations comprising: commanding the radio to transmit to the UE sub-band full duplex (SBFD) information in a cell-specific manner in a full-duplex operation in a time division duplex-uplink-downlink (tdd-UL-DL) configuration common configurations in system information block 1 (SIB1) to define time locations of cell-specific SBFD symbols and slots. In one embodiment, the radio is to further transmit to the UE an uplink configuration common SIB in SIB1 to define UL sub-bands including cell-specific SBFD symbols and slots. In one embodiment, the tdd-UL-DL common configuration comprises a reference subcarrier spacing (SCS) configuration by referenceSubcarrierSpacing and a pattern. In one embodiment, the pattern comprises a slot configuration of P milliseconds by dl-UL-transmission periodicity and a predefined number of slots with downlink symbols or SBFD symbols. In one embodiment, any slot of the predefined number of slots includes only downlink symbols or SBFD symbols. In one embodiment, a bit map length of a slot indicates whether a slot includes downlink symbols or SBFD symbols. In one embodiment, the pattern further comprises slots with only uplink symbols.

Other methods and apparatuses are also described.

### BRIEF DESCRIPTION OF THE DRAWINGS

The present invention is illustrated by way of example and not limitation in the figures of the accompanying drawings in which like references indicate similar elements.

FIG. 1 illustrates an example wireless communication system according to one embodiment of the disclosure.

FIG. 2 illustrates user equipment in direct communication with a base station (BS) according to one embodiment of the disclosure.

FIG. 3 illustrates an example block diagram of a UE according to one embodiment of the disclosure.

FIG. 4 illustrates an example block diagram of a BS according to one embodiment of the disclosure.

FIG. 5 illustrates an example block diagram of cellular communication circuitry according to one embodiment of the disclosure.

FIG. 6 illustrates a flow diagram of a process to implement radio resource management for the UE according to one embodiment of the disclosure.

FIG. 7 illustrates a diagram of a SMTC window, in which, SSB blocks are included, that can be used in accordance with embodiments of the disclosure.

FIG. 8 illustrates a diagram that the UE can be indicated in a cell-specific manner about SBFD symbols according to one embodiment of the disclosure.

FIG. 9 illustrates a diagram of an example of the transmission of SBFD symbol indications (e.g., in an RRC inactive/idle implementation) according to one embodiment of the disclosure.

### DETAILED DESCRIPTION

In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “some embodiments” or “an embodiment” means that a particular feature, structure, or characteristic described in connection with the embodiment can be included in at least one embodiment of the invention. The appearances of the phrase “in some embodiments” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

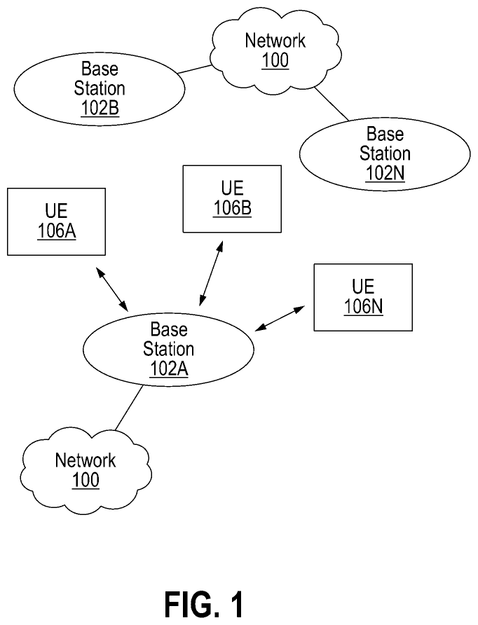

FIG. 1 illustrates a simplified example wireless communication system according to one aspect of the disclosure. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1xRTT, 1xEV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

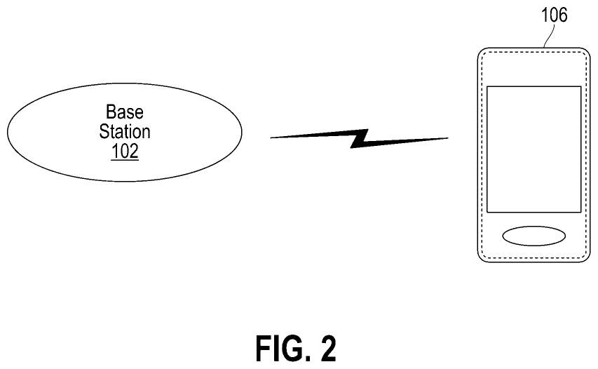

FIG. 2 illustrates a UE 106 in direct communication with a base station 102 through uplink and downlink communications according to one aspect of the disclosure. The UE 106 may be a device with cellular communication capability such as a mobile phone, a hand-held device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1xRTT or LTE or GSM), and separate radios for communicating using each of Wi-Fi and Bluetooth. Other configurations are also possible.

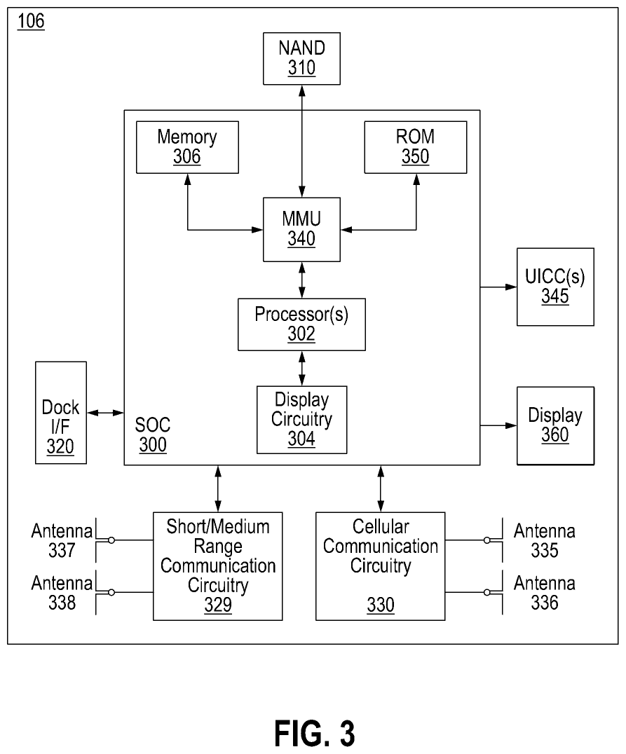

FIG. 3 illustrates an example simplified block diagram of a communication device 106 according to one aspect of the disclosure. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly. dedicated processors and/or radios) for multiple radio access technologies (RATs) (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. The communication device 106 may also be configured to determine a physical downlink shared channel scheduling resource for a user equipment device and a base station. Further, the communication device 106 may be configured to group and select CCs (component carriers) from the wireless link and determine a virtual CC from the group of selected CCs. The wireless device may also be configured to perform a physical downlink resource mapping based on an aggregate resource matching patterns of groups of CCs.

As described herein, the communication device 106 may include hardware and software components for implementing the above features for determining a physical downlink shared channel scheduling resource for a communications device 106 and a base station. The processor 302 of the communication device 106 may be configured to implement part or all of the features described herein, e.g., by executing program instructions stored on a memory medium (e.g., a non-transitory computer-readable memory medium). Alternatively, (or in addition), processor 302 may be configured as a programmable hardware element, such as an FPGA (Field Programmable Gate Array), or as an ASIC (Application Specific Integrated Circuit). Alternatively, (or in addition), the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 230. Similarly, the short range wireless communication circuitry 329 may include one or more ICs that are configured to perform the functions of short range wireless communication circuitry 32. In addition, each integrated circuit may include circuitry (e.g., first circuitry, second circuitry, etc.) configured to perform the functions of short range wireless communication circuitry 329.

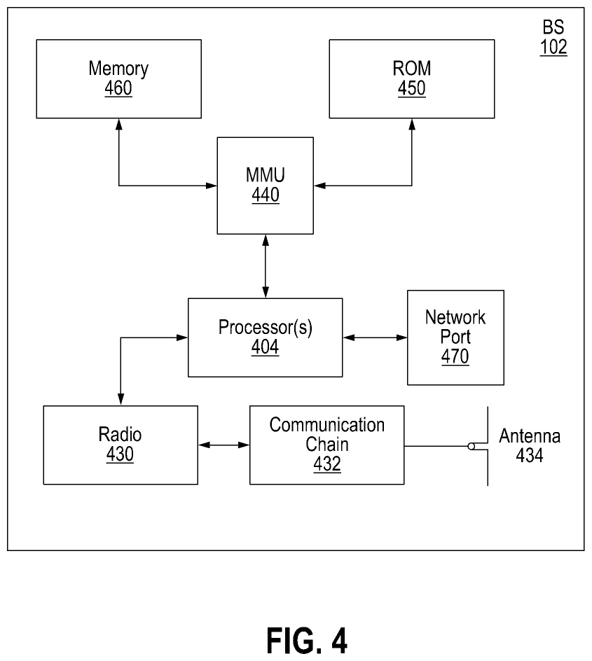

FIG. 4 illustrates an example block diagram of a base station 102 according to one aspect of the disclosure. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UEs 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UEs 106. In some cases, the network port 470 may couple to a telephone network via the core network, and/or the core network may provide a telephone network (e.g., among other UEs serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UEs 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively, (or in addition), the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

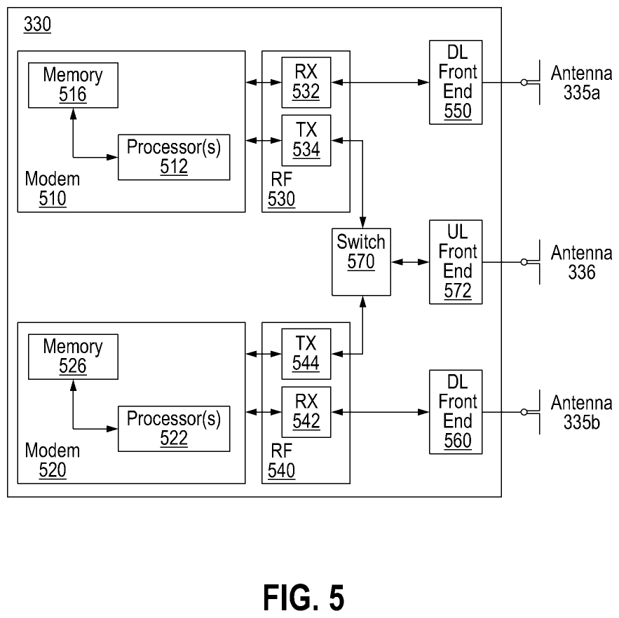

FIG. 5 illustrates an example simplified block diagram of cellular communication circuitry according to one aspect of the disclosure. It is noted that the block diagram of the cellular communication circuitry of FIG. 5 is only one example of a possible cellular communication circuit. According to embodiments, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335 a-b and 336 as shown (in FIG. 3). In some embodiments, cellular communication circuitry 330 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for selecting a periodic resource part for a user equipment device and a base station, as well as the various other techniques described herein. The processors 512 may be configured to implement part or all of the features described herein, e.g., by executing program instructions stored on a memory medium (e.g., a non-transitory computer-readable memory medium). Alternatively, (or in addition), processor 512 may be configured as a programmable hardware element, such as an FPGA (Field Programmable Gate Array), or as an ASIC (Application Specific Integrated Circuit). Alternatively, (or in addition), the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for selecting a periodic resource on a wireless link between a UE and a base station, as well as the various other techniques described herein. The processors 522 may be configured to implement part or all of the features described herein, e.g., by executing program instructions stored on a memory medium (e.g., a non-transitory computer-readable memory medium). Alternatively, (or in addition), processor 522 may be configured as a programmable hardware element, such as an FPGA (Field Programmable Gate Array), or as an ASIC (Application Specific Integrated Circuit). Alternatively, (or in addition), the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

As has been described, in wireless communications networks, full-duplex (FD) operation within a time division duplex (TDD) band and in frequency division duplex (FDD) band is being envisaged for enhancements for communications between base stations (e.g., gNBs) and UEs (e.g., Rel-18 enhancements). In this instance, FD operations refer to the case, in which, at least the base station is operating in full-duplex, i.e., simultaneously, transmitting and receiving data. For example, in Rel-18, dynamic TDD and full duplex operations at the base station are being studied under the assumption of a half-duplex UE.

It would be beneficial to have UL sub-bands configured in SSB symbols by the UE to provide more UL opportunities. This may be dependent upon synchronization signal block (SSB) configuration, the SSB measurement timing configuration window (SMTC), and other considerations. However, some concerns may be that UE-to-UE cross-link interference (CLI) may degrade the performance of SSB detection/measurement at a victim UE.

Embodiments relate to a method and apparatus for radio resource management (RRM) for user equipment (UE) in communication with a base station that accounts for collision between uplink (UL) sub-band and synchronization signal block (SSB) symbols. In particular, as will be described, embodiments relate to the following aspects: conditions under which an aggressor UE can keep UL transmission sub-bands in SSB symbols; and solutions for a victim UE if a base station (gNB) is performing sub-band full duplex (SBFD) operations in SSB symbols-as SSB measurements over such SSB blocks may be degraded due to UE-to-UE CLI, and/or less antenna elements/beam-forming gain at the base station (gNB).

In one embodiment, a method for a user equipment (UE) in communication with a base station is disclosed that comprises: receiving a bit mask at the UE, the bit mask indicating whether the UE is to use a synchronization signal block (SSB) overlapping with sub-band full duplex (SBFD) symbols for SSB measurement or uplink (UL) transmission; and based upon the received the bit mask, the UE performs SSB measurement or uplink (UL) transmission.

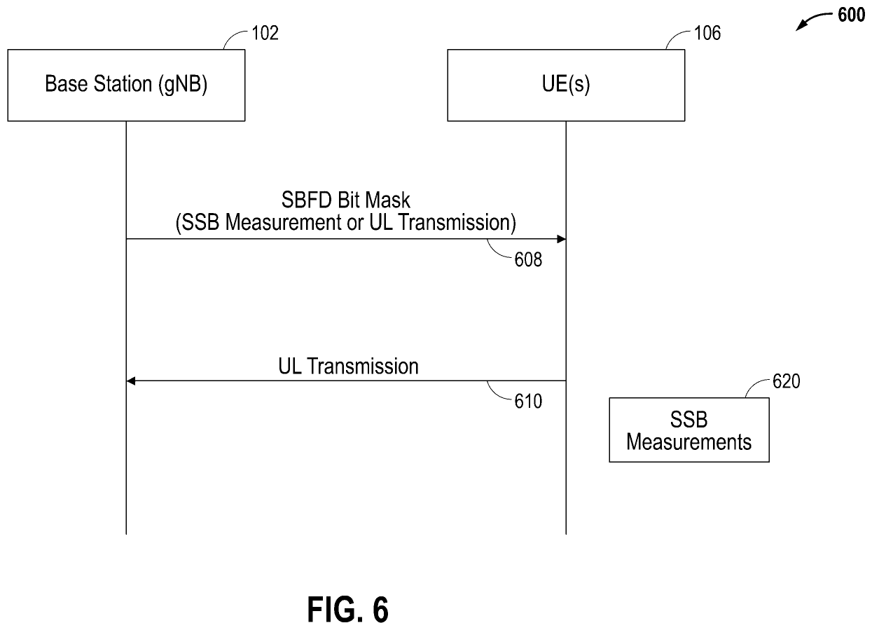

With reference to FIG. 6, FIG. 6 shows a flow diagram of a process 600 to implement radio resource management (RRM) for the UE 106. As can be seen in FIG. 6, the process 600 for UE 106 in communication with a base station 102 (hereinafter referred to as gNB 102) is disclosed. In one embodiment, gNB 102 may transmit a sub-band full duplex (SBFD) bit mask 608 to be received by UE 106, in which, the bit mask 608 indicates whether UE 106 is to use a SSB overlapping with SBFD symbols for SSB measurement or uplink (UL) transmission. Based upon the received the bit mask 608, the UE performs SSB measurements 620 or uplink (UL) transmission 610.

As previously described, gNB 102 transmits a bit mask to the UE 106, indicating whether a SSB block overlapping with SBFD symbols can be used for SSB measurement or for UL transmission. The bit mask 608 can be indicated as cell specific, in which it is signaled through system information block 1 (SIB1) or through SIB3. Alternatively, bit mask 608 may be UE-specific, and may be signaled through radio resource control (RRC), for example as part of a SSB measurement timing configuration (SMTC) window.

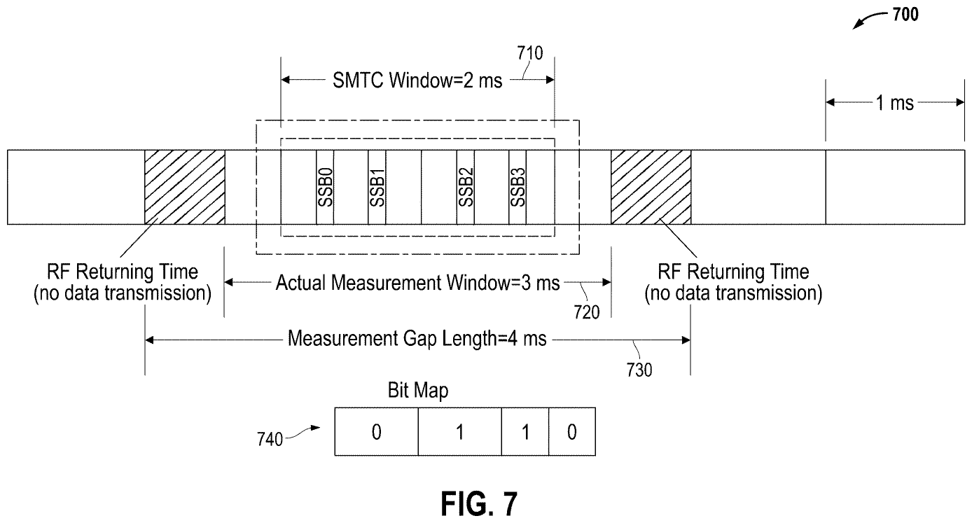

With additional reference to FIG. 7, a diagram of a SMTC window is shown in which, SSB blocks are included, that can be used in accordance with embodiments. As shown, a SMTC window 710 includes a plurality SSBs (e.g., SSB0, SSB1, SSB2, SSB3) that occur in an actual measurement window 720 and a complete measurement gap length 730. In one embodiment, an example bit map 740 may be utilized. For example, the first/leftmost bit corresponds to SS/PBCH block index 0 and the second bit corresponds to SS/PBCH block index 1, and so on. In one embodiment, value 0 in the bitmap indicates that the corresponding SS/PBCH block is not to be measured, so that an aggressor UE 106 can use UL sub-band for UL transmission. In one embodiment, value 1 indicates that the corresponding SS/PBCH block is to be measured within the applicable STMC window by the UE. Alternatively, in other embodiments, an existing mask ssb-ToMeasure can be repurposed to resolve collision between SBFD and SSB symbols. It should be noted that ssb-ToMeasure defines the set of SS blocks to be measured within the SMTC measurement duration. It should further be noted that, when the bit mask field is not configured, UE 106 measures on all SSBs. Further, regardless of the value in the field, SS/PBCH blocks outside of the SMTC window 710 are not to be measured so that an aggressor UE can potentially use UL sub-bands in SBFD symbols overlapping with SSB symbols.

It should be appreciated if an aggressor UE 106 is indicated to be allowed to use an UL sub-band in the SSB symbols, such transmission potentially increase UE-to-UE cross-link interference (CLI). Because of this, a victim UE (e.g., another UE) measuring the same SSB symbols may observe degraded SSB symbols. In one embodiment, in order to manage UE-to-UE CLI at the victim UE measuring SSB over symbols overlapping with SBFD symbols, various example solutions may be utilized. As one example, UL transmission within SSB symbols may follow a specific procedure. For example, a reduced maximum UE transmit power (P_{T}<P_{C,Max}) may be applied. Additionally, or alternatively, if UL transmit power of an aggressor UE 106 is determined to be more than P_{T}, UL transmission in SSB symbols may be canceled. As another example embodiment, gNB 102 may apply more transmit power to such SSB symbols to compensate for UE-to-UE CLI and/or reduced beam forming gain at gNB. As yet another example embodiment, unified signaling may be expected by gNB 102, so if the aggressor UE is indicated to use UL-subbands in SBFD symbols overlapping with SSB symbols, victim UE shall be indicated not to measure SSB over the same SSB symbols.

In radio access network 1 (RAN1) implementation, it is common understanding that, at least for RRC_CONNECTED UEs, SBFD indication is based on RRC signaling. However, overlapping between SBFD and SSB symbols may be envisioned for SBFD indication before RRC connection. The use case may be to use UL sub-bands for physical random access channel (PRACH) and/or Msg3.

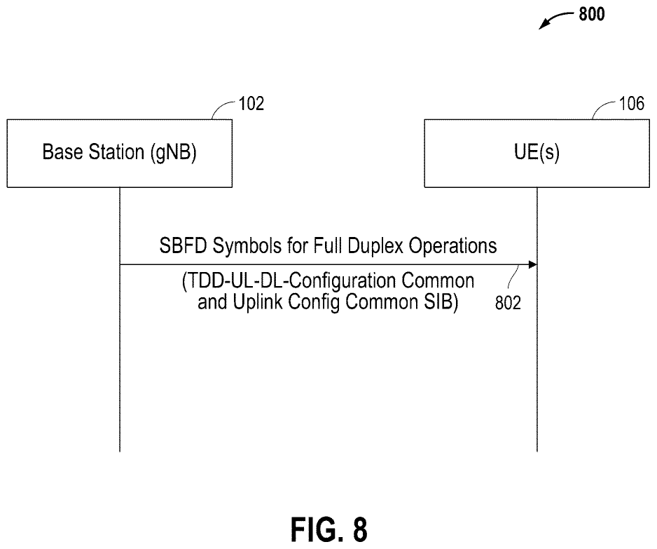

RRC inactive and/or Idle SBFD symbol indications will be described. With additional reference to FIG. 8, UE 106 can be indicated in a cell-specific manner about SBFD symbols in which gNB 102 is doing full-duplex operation. As an example, gNB 102 can transmit to the UE 106 sub-band full duplex (SBFD) information in a cell-specific manner in a full-duplex operation (802). In particular, a time division duplex-uplink-downlink (tdd-UL-DL) configuration common configurations in system information block 1 (SIB1) can be transmitted to define time locations of cell-specific SBFD symbols and slots. Further, a UplinkConfigCommonSIB in SIB1 may be transmitted which defines UL sub-bands within cell-specific SBFD symbols/slots. It should be noted that by default, UL sub-band in common SBFD symbols can be assumed to have same/similar configurations as initialUplinkBWP.

In one embodiment, for cell-specific SBFD indication, additional configurations to tdd-UL-DL-ConfigurationCommon, will be described. To begin with, the tdd-UL-DL-ConfigurationCommon provides: a reference SCS configuration μ_{ref} by referenceSubcarrierSpacing and a pattern (e.g., pattern1). In one embodiment, pattern 1 provides: a slot configuration period of P msec by dl-UL-TransmissionPeriodicity; and a number of slots (e.g., dₛₗₒₜ) with only downlink symbols or only SBFD symbols by nrofDownlinkSlots.

In one example embodiment, any slot out of dₛₗₒₜ slots consists of only D symbols or only SBFD symbols (or for transition between legacy slots with only D symbols and new slots with only SBFD symbols). Further, a bit map of length dₛₗₒₜ indicates which slots are only D symbols or only SBFD symbols. It should be noted that the first bit (and last bit) with value 1 are proceeded (followed) by S slots (e.g., S=1 or S=0.5) for transition. Additionally, pattern 1 provides: a number of downlink symbols—e.g., d_{sym} by nrofDownlinkSymbols; a number of slots—e.g., uₛₗₒₜ with only uplink symbols by nrofUplinkSlots; and a number of uplink symbols—e.g., u_{sym} by nrofUplinkSymbols.

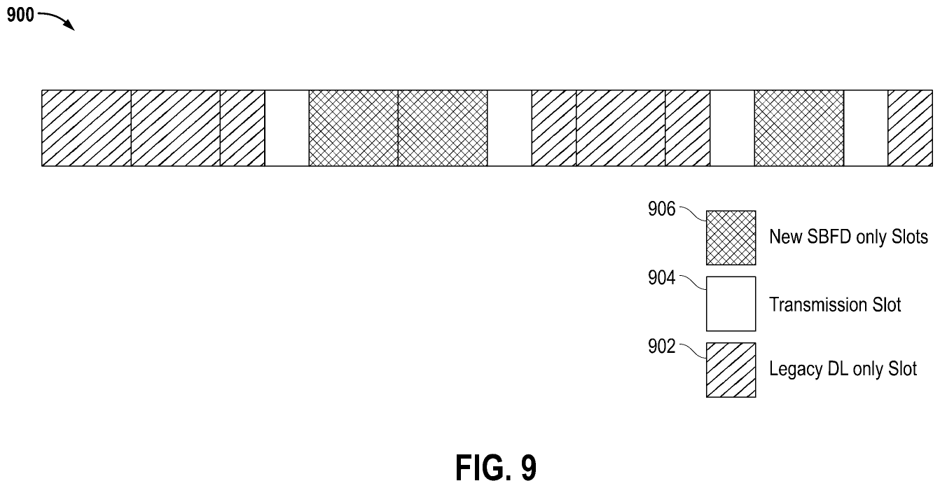

With additional reference to FIG. 9, an example of the transmission of SBFD symbol indications (e.g., in RRC inactive/idle implementation), will be described. In this example: dₛₗₒₜ=10 and S=0.5 and the bitmap is 0001100010. Legacy DL only slots are blocks 902; transmission slots are 904; and new SBFD only slots are 906. In this example of FIG. 9 there are 10 slots (dₛₗₒₜ) and S=0.5 for transmission. As can be seen in FIG. 9, under this implementation, from left to right, based on the bitmap 0001100010, FIG. 9 shows: legacy slot 902, legacy slot 902, ½ legacy slot 902 and ½ transmission slot 904, new SBFD slot 906, new SBFD slot 906, ½ transmission slot 904 and ½ legacy slot 902, legacy slot 902, ½ legacy slot 902 and ½ transmission slot 904, new SBFD slot 906, and ½ transmission slot 904 and ½ legacy slot 902. This methodology provides an effective way of providing SBFD symbols to a UE in an RRC inactive/idle environment.

It should be appreciated that the operations of the previously described processes in some embodiments may be performed: at the UE 106 including: a processor, communication interfaces, antenna, a radio, etc., to implement the previously described processes; and/or at the base station (e.g., gNB) 102 including: a processor, communication interfaces, antenna, a radio, etc., to implement the previously described processes.

Portions of what was described above may be implemented with logic circuitry such as a dedicated logic circuit or with a microcontroller or other form of processing core that executes program code instructions. Thus, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

For example, the previously described embodiment operations may be stored as instructions on a non-transitory computer readable medium for execution by a computer (e.g., a UE). The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMS, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

1. A method for radio resource management (RRM) for a user equipment (UE) in communication with a base station comprising:
receiving a bit mask at the UE, the bit mask indicating whether the UE is to use a synchronization signal block (SSB) overlapping with sub-band full duplex (SBFD) symbols for SSB measurement or uplink (UL) transmission; and
based upon the received the bit mask, the UE performs SSB measurement or uplink (UL) transmission.

2. The method of claim 1, wherein, the bit mask is cell specific or UE-specific.

3. The method of claim 1, wherein, a pre-defined value of the bit mask indicates that SSB measurement is not to be performed and the UE is to perform UL transmission in an UL sub-band.

4. The method of claim 1, wherein, a pre-defined value of the bit mask indicates that SSB measurement is to be performed and the SSB block is to be measured within a corresponding SSB Measurement Timing Configuration (SMTC).

5. The method of claim 1, wherein, the UL transmission within SSB symbols includes a reduced maximum UE transmit power.

6. The method of claim 1, wherein, the base station applies additional transmit power to SSB symbols.

7. The method of claim 1, wherein, when the UE is performing SSB measurements, the UE does not measure SSB symbols that overlap with SBFD symbols.

8. A user equipment (UE) to implement radio resource management (RRM) for the UE, the UE in connection with a base station, the UE comprising:
at least one antenna;
at least one radio, wherein the at least one radio is configured to communicate with the base station using the at least one antenna; and
at least one processor coupled to the at least one radio, wherein the at least one processor is configured to perform operations comprising:
receiving a bit mask, the bit mask indicating whether the UE is to use a synchronization signal block (SSB) overlapping with sub-band full duplex (SBFD) symbols for SSB measurement or uplink (UL) transmission; and
based upon the received the bit mask, performing SSB measurement or uplink (UL) transmission.

9. The UE of claim 8, wherein, the bit mask is cell specific or UE-specific.

10. The UE of claim 8, wherein, a pre-defined value of the bit mask indicates that SSB measurement is not to be performed and the UE is to perform UL transmission in an UL sub-band.

11. The UE of claim 8, wherein, a pre-defined value of the bit mask indicates that SSB measurement is to be performed and the SSB block is to be measured within a corresponding SSB Measurement Timing Configuration (SMTC).

12. The UE of claim 8, wherein, the UL transmission within SSB symbols includes a reduced maximum UE transmit power.

13. The UE of claim 8, wherein, when performing SSB measurements, not measuring SSB symbols that overlap with SBFD symbols.

14-18. (canceled)

19. A base station to implement radio resource management (RRM) with a UE, the base station in connection with the UE through a network, the base station comprising:
at least one antenna;
at least one radio, wherein the at least one radio is configured to communicate with the network using the at least one antenna; and
at least one processor coupled to the at least one radio, wherein the at least one processor is configured to perform operations comprising:
commanding the radio to transmit to the UE sub-band full duplex (SBFD) information in a cell-specific manner in a full-duplex operation in a time division duplex-uplink-downlink (tdd-UL-DL) configuration common configurations in system information block 1 (SIB1) to define time locations of cell-specific SBFD symbols and slots.

20. The base station of claim 19, further comprising the radio to transmit to the UE an uplink configuration common SIB in SIB1 to define UL sub-bands including cell-specific SBFD symbols and slots.

21. The base station of claim 20, wherein, the tdd-UL-DL common configuration comprises a reference subcarrier spacing (SCS) configuration by referenceSubcarrierSpacing and a pattern.

22. The base station of claim 21, wherein, the pattern comprises a slot configuration of P milliseconds by dl-UL-transmission periodicity and a predefined number of slots with downlink symbols or SBFD symbols.

23. The base station of claim 22, wherein, any slot of the predefined number of slots includes only downlink symbols or SBFD symbols.

24. The base station of claim 23, wherein, a bit map length of a slot indicates whether a slot includes downlink symbols or SBFD symbols.

25. The base station of claim 24, wherein, the pattern further comprises slots with only uplink symbols.
